(19) United States
(12) Patent Application Publication
(10) Pub. No.: US 2023/0147126 A1
(43) Pub. Date: May 11, 2023

(54) TRANSPORTATION MANAGEMENT SYSTEM, TRANSPORTATION MANAGEMENT METHOD, AND PROGRAM

(71) Applicant: TOYOTA JIDOSHA KABUSHIKI KAISHA, Toyota-shi Aichi-ken (JP)

(72) Inventors: Kunihiro IWAMOTO, Toyota-shi Aichi-ken (JP); Yuta ITOZAWA, Nagoya-shi Aichi-ken (JP); Hirotaka KOMURA, Setagaya-ku Tokyo-to (JP)

(73) Assignee: TOYOTA JIDOSHA KABUSHIKI KAISHA, Toyota-shi Aichi-ken (JP)

(21) Appl. No.: 17/980,615

(22) Filed: Nov. 4, 2022

(30) Foreign Application Priority Data
Nov. 8, 2021 (JP) 2021-182094

(51) Int. Cl. G06Q 10/0833; G01C 21/34

(52) U.S. Cl. CPC G06Q 10/0833; G01C 21/3438

(57) ABSTRACT

To provide a transportation management system, a transportation management method, and a program each adapted to improve operational efficiency of an operation plan including a transportation route of a first transportation vehicle and a transportation route of a second transportation vehicle capable of accommodating the first transportation vehicle. A transportation management system manages transportation of a package by a plurality of first transportation vehicles and a second transportation vehicle capable of accommodating the plurality of the first transportation vehicles. The transportation management system includes a generation unit configured to generate an operation plan including a transportation route of each of the plurality of the first transportation vehicles and a transportation route of the second transportation vehicle. The generation unit generates the operation plan for the case where passing of the package between the plurality of the first transportation vehicles inside the second transportation vehicle is permitted.

### CROSS REFERENCE TO RELATED APPLICATIONS

This application is based upon and claims the benefit of priority from Japanese patent application No. 2021-182094, filed on Nov. 8, 2021, the disclosure of which is incorporated herein in its entirety by reference.

### BACKGROUND

The present disclosure relates to a transportation management system, a transportation management method, and a program.

Japanese Unexamined Patent Application Publication No. 2019-128801 discloses a transportation management technique for performing transportation of a package using a compact transportation vehicle such as a transportation robot and a large-sized transportation vehicle that can accommodate the compact vehicle.

### SUMMARY

In generating an operation plan including a transportation route of a first transportation vehicle and a transportation route of a second transportation vehicle capable of accommodating the first transportation vehicle, it is desired to generate an operation plan in which the operation efficiencies of the first transportation vehicle and the second transportation vehicle are improved.

The present disclosure has been made to solve the problem mentioned above and an object of the present disclosure is to provide a transportation management system, a transportation management method, and a program each adapted to improve operational efficiency of an operation plan including a transportation route of a first transportation vehicle and a transportation route of a second transportation vehicle capable of accommodating the first transportation vehicle.

A transportation management system according to an embodiment is a transportation management system for managing transportation of a package by a plurality of first transportation vehicles and a second transportation vehicle capable of accommodating the plurality of the first transportation vehicles, the transportation management system including

a generation unit configured to generate an operation plan including a transportation route of each of the plurality of the first transportation vehicles and a transportation route of the second transportation vehicle, in which

the generation unit generates the operation plan for the case where passing of the package between the plurality of the first transportation vehicles inside the second transportation vehicle is permitted.

A transportation management method according to an embodiment is a transportation management method of managing transportation of a package by a plurality of first transportation vehicles and a second transportation vehicle capable of accommodating the plurality of the first transportation vehicles, the transportation management method including:

a generation step in which a computer generates an operation plan including a transportation route of each of the plurality of the first transportation vehicles and a transportation route of the second transportation vehicle, in which

in the generation step, the operation plan is generated for the case where passing of the package between the plurality of the first transportation vehicles inside the second transportation vehicle is permitted.

A program according to an embodiment is a program for causing a computer to execute a transportation management method of managing transportation of a package by a plurality of first transportation vehicles and a second transportation vehicle capable of accommodating the plurality of the first transportation vehicles, the transportation management method including

a generation step of generating an operation plan including a transportation route of each of the plurality of the first transportation vehicles and a transportation route of the second transportation vehicle, in which

in the generation step, the operation plan is generated for the case where passing of the package between the plurality of the first transportation vehicles inside the second transportation vehicle is permitted.

According to the present disclosure, a transportation management system, a transportation management method, and a program each adapted to improve operational efficiency of an operation plan including a transportation route of a first transportation vehicle and a transportation route of a second transportation vehicle capable of accommodating the first transportation vehicle can be provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic configuration diagram showing a configuration of a transportation management system according to a first embodiment;

FIG. 2 is a block diagram showing a configuration of a first transportation vehicle according to the first embodiment;

FIG. 3 is a block diagram showing a configuration of a server according to the first embodiment; and

FIG. 4 is a schematic diagram showing an example of an operation plan generated in the transportation management method according to the first embodiment.

### DESCRIPTION OF EMBODIMENTS

### First Embodiment

Hereinbelow, the present disclosure will be described through embodiments, but the embodiments are not intended to limit the scope of the present disclosure according to the claims. Further, not all of the components/structures described in the embodiments are necessarily indispensable for solving the problem.

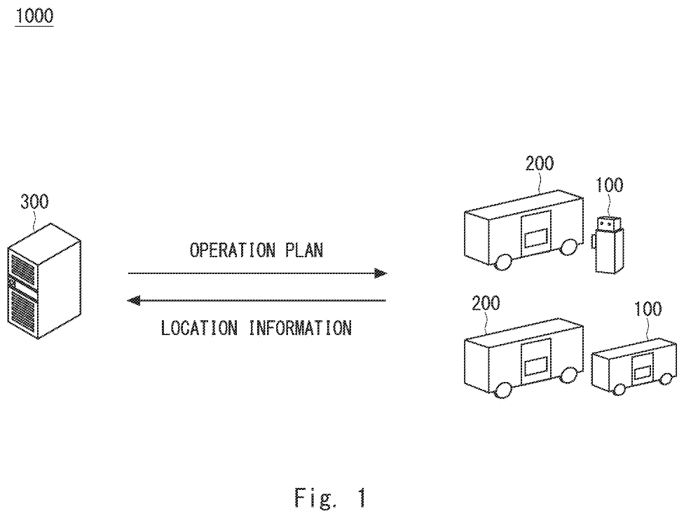

Hereinbelow, a transportation management system according to a first embodiment will be described with reference to the drawings. FIG. 1 is a schematic diagram showing an overview of a transportation management system 1000 according to the first embodiment. The transportation management system 1000 includes a plurality of transportation vehicles 100, a plurality of transportation vehicles 200, and a server 300. The transportation vehicle 100 is also referred to as a first transportation vehicle and the transportation vehicle 200 is also referred to as a second transportation vehicle. The number of the transportation vehicle 200 may be one. The transportation management system 1000 is a system for managing transportation of a package by the plurality of the transportation vehicles 100 and the transportation vehicle 200 capable of accommodating the plurality of the transportation vehicles 100.

The function of the server 300, which will be described later, may be provided in the transportation vehicles 100 and the transportation vehicle 200. Therefore, a system which does not include the server 300 may also be included in the transportation management system 1000 according to the first embodiment.

The transportation vehicle 100 is a transportation vehicle smaller in size than the transportation vehicle 200, which will be described later. As described above, the transportation vehicle 100 may be a transportation robot or a compact automobile. The transportation vehicle 100 can be accommodated in the below-described transportation vehicle 200. For example, when the transportation vehicle 200 has a function of a bus for transporting humans, the transportation vehicle 100 gets into the transportation vehicle 200 from the entrance and exit used by humans or the entrance and exit dedicated to vehicles. Further, the transportation vehicle 100 may get into the cargo bed of the transportation vehicle 200. The transportation vehicle 100 performs transportation work at a place which the transportation vehicle 200 cannot enter (e.g. in an area around a house).

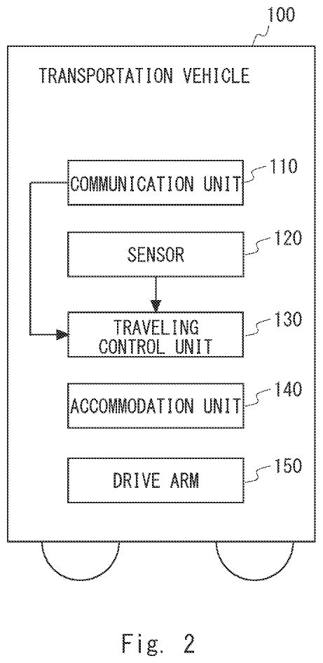

FIG. 2 is a block diagram showing a functional configuration of the transportation vehicle 100. The transportation vehicle 100 includes a communication unit 110, a sensor 120, a traveling control unit 130, an accommodation unit 140, and a drive arm 150.

The communication unit 110 is a communication interface. The transportation vehicle 100 receives, via the communication unit 110, an operation plan from the server 300, which will be described later. Further, the transportation vehicle 100 sends, via the communication unit 110, the location information of the transportation vehicle 100 to the serer 300. When delivery of a package has been completed, the transportation vehicle 100 may be further send a notification to the server 300 to the effect that delivery of the package has been completed.

The sensor 120 collects environmental data of the area surrounding the transportation vehicle 100 and outputs the collected environmental data to the traveling control unit 130. The sensor 120 may be, for example, a camera, a radar, LIDAR, or the like. Using the environmental data collected by the sensor 120, the traveling control unit 130 causes the transportation vehicle 100 to move autonomously in accordance with the operation plan. The transportation vehicle 100 acquires its own location through GPS (Global Positioning System), the sensor 120, or the like.

The accommodation unit 140 has a function of accommodating a package. The accommodation unit 140 may be configured to be able to accommodate a plurality of packages, and a specific example of such a configuration is a shelf. In the case where the accommodation unit 140 is a shelf, the packages may be boxes. In such a case, the server 300, which will be described later, may manage which part of the shelf is occupied or not. Further, the accommodation unit 140 may be provided with a locking mechanism. In such a case, the transportation vehicle 100 executes control to release the locking mechanism of the accommodation unit 140 at the timing of arrival at the delivery destination or at the timing of passing of a package between the transportation vehicle 100 and another transportation vehicle 100.

The drive arm 150 receives a package from the delivery origin and accommodates the received package in the accommodation unit 140. Further, the drive arm 150 takes out the package from the accommodation unit 140 and stores the package in a postbox or the like at the delivery destination. The drive arm 150 is used for passing packages between the transportation vehicle 100 and another transportation vehicle 100. For example, the drive arm 150 of the transportation vehicle 100 takes out a package from the accommodation unit 140 of another transportation vehicle 100 and stores it in the accommodation unit 140 of the transportation vehicle 100. Further, for example, the drive arm 150 may take out a package from a package collecting spot located inside the transportation vehicle 200 and store the package it took out into the accommodation unit 140.

Referring again to FIG. 1, the transportation vehicle 100 moves autonomously in accordance with the operation plan generated by the server 300, which will be described later. The transportation vehicle 100 travels to a designated location and then gets into the transportation vehicle 200. Then, the transportation vehicle 100 is conveyed together with the package by the transportation vehicle 200. The transportation vehicle 100 then gets out of the transportation vehicle 200 at the designated location and transports the package to the delivery destination.

In the operation plan, passing of a package between the plurality of the transportation vehicles 100 inside the transportation vehicle 200 is permitted. The plurality of the transportation vehicles 100 may directly pass the package or pass the package via a package collecting place (e.g. a shelf). Specifically, one of the transportation vehicles 100 having a plurality of packages may pass a portion of the plurality of packages to another transportation vehicle 100. The transportation vehicle 100 that has received the package gets out of the transportation vehicle 200 in accordance with the operation plan and transports the package to the delivery destination. Note that a crew member of the transportation vehicle 200 may move the package between the plurality of the transportation vehicles 100 in accordance with the operation plan.

The transportation vehicle 200 is a large-sized transportation vehicle larger than the transportation vehicle 100. The transportation vehicle 200 is capable of accommodating the plurality of the transportation vehicles 100. The transportation vehicle 200 may be capable of accommodating more than two transportation vehicles 100. The transportation vehicle 200 may be an unmanned self-driving vehicle called an Electric Vehicle (EV) pallet. Note that a crew member may get in the transportation vehicle 200. The crew member may confirm the operation plan based on the display shown on a display disposed inside the transportation vehicle 200.

The transportation vehicle 200 can travel at a speed faster than that of the transportation vehicle 100. For example, the transportation vehicle 200 may travel on the roadway and the transportation vehicle 100 may travel on the sidewalk. Note that the transportation vehicle 200 may be an autonomously moving vehicle or a vehicle that is driven or assisted by a human driver.

As described above, the transportation vehicle 200 may be provided with a function of a bus intended to transport humans. In such a case, the inside of the transportation vehicle 200 may serve as a shared space for the transportation robots and humans. The transportation vehicle 200 that is a transportation robot may use the same entrance and exit as those used by humans or may use the entrance and exit dedicated to vehicles.

The transportation vehicle 200 receives an operation plan from the server 300, which will be described later, and moves in accordance with the operation plan. The transportation vehicle 200 may move autonomously in accordance with the operation plan. Further, the driver may make the transportation vehicle 200 to travel along the transportation route included in the operation plan. Then the transportation vehicle 200 sends the location information of the transportation vehicle 200 to the server 300.

The server 300 is a computer with a memory, a processor, and so on. The server 300 manages the location information of each of the plurality of the transportation vehicles 100 and the location information of the transportation vehicle 200. Further, the server 300 generates a delivery plan of a package based on the location information of each of the plurality of the transportation vehicles 100 and the location information of the transportation vehicle 200. The delivery plan is also referred to as the operation plan and includes the transportation route of each of the plurality of the transportation vehicles 100 and the transportation route of the transportation vehicle 200.

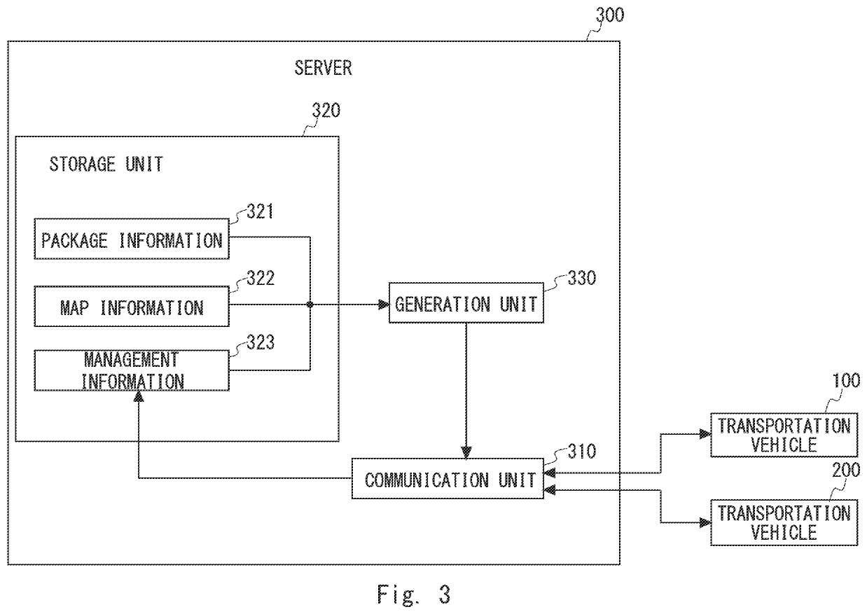

Next, the server 300 will be described in detail with reference to FIG. 3. The server 300 includes a communication unit 310, a storage unit 320, and a generation unit 330. The communication unit 310 is a communication interface and the server 300 performs communication with the transportation vehicle 100 and the transportation vehicle 200 via the communication unit 310.

The storage unit 320 is a storage apparatus such as a hard disk, a flash memory, or the like. Further, the storage unit 320 may include a volatile storage apparatus such as a RAM (Random Access Memory) that is a storage area for temporarily holding information.

The storage unit 320 stores package information 321, map information 322, and management information 323. The package information 321 includes delivery origin information and delivery destination information of each of the plurality of the packages. The package information 321 may further include the degree of relative priority (hereinbelow referred to as the priority levels) of the packages.

The map information 322 is map data including the delivery area and is used when the generation unit 330, which will be described later, generates the operation plan. The map information 322 may be, for example, data of a road map in which nodes representing intersections or the like and links representing pathways are numbered. Alternatively, the map information 322 may be an environment map representing the areas such as buildings that may be obstructions.

The management information 323 includes location information of each of the plurality of the transportation vehicles 100 and the location information of the transportation vehicle 200. The location information may be, for example, GPS location information. Further, the management information 323 may further include first status information indicating whether or not each of the plurality of vehicles 100 is delivering a package and second status information indicating the availability status of the accommodation unit 140. A transportation vehicle 100 which is not currently delivering any package and a transportation vehicle 100 whose accommodation unit 140 is available can receive a package from another transportation vehicle 100 and perform delivery work. The information about the availability of the accommodation unit 140 may be information about weight and volume.

The generation unit 330 generates an operation plan for the transportation vehicle 100 and the transportation vehicle 200 based on the package information 321, the map information 322, and the management information 323. The operation plan includes the transportation route of each of the plurality of the transportation vehicles 100 and the transportation route of the transportation vehicle 200. Further, the operation plan includes instructions to pass a package between the plurality of the transportation vehicles 100.

The generation unit 330 generates the operation plan for the case where passing of the package between the plurality of the transportation vehicles 100 inside the transportation vehicle 200 is permitted. In such a case, since a plurality of transportation vehicles 100 can work together to transport packages, the server 300 can improve the operation efficiency of the operation plan.

The generation unit 330 may generate an operation plan for the case where passing of the package is performed and an operation plan for the case where passing of the package is not performed and adopt the operation plan which is the most efficient (for example, an operation plan in which the transportation time is the shortest one). In the case where passing of the package is performed, for example, the transportation vehicle 100 that performs passing of the package may be selected based on the location information and then the locations where the selected transportation vehicle 100 gets into and gets out of the transportation vehicle 200 are determined, thereby generating the operation plan. In generating the operation plan, any known algorithm can be employed.

The generation unit 330 sends the generated operation plan to the transportation vehicle 100 and the transportation vehicle 200. The transportation vehicle 100 and the transportation vehicle 200 move autonomously in accordance with the operation plan and deliver the package to the delivery destination. Note that as described above, the driver may make the transportation vehicle 200 to travel along the transportation route.

The generation unit 330 may generate the operation plan based on the first status information, the second status information, and the priority levels of the package. When the priority levels of the package is low, the generation unit 330, for example, generates an operation plan using only the location information of the transportation vehicle 100 that is currently not performing any delivery work. When the priority levels of the package is high, the generation unit 330 generates an operation plan taking into account the location information of the transportation vehicle 100 whose accommodation unit 140 is available among the transportation vehicles 100 that are currently performing delivery work.

The generation unit 330 may update the operation plan as needed in accordance with the update of the management information 323. By this configuration, it is possible to efficiently transport a package using a transportation vehicle 100 which has finished its transportation work or a transportation vehicle 100 which has moved to the vicinity of the transportation vehicle 200. For example, the generation unit 330 may change the operation plan in the case where the operation efficiency of the newly generated operation plan is higher than the operation efficiency of the originally generated operation plan. The generation unit 330 may change the operation plan if the delivery time can be shortened for the package with high priority levels.

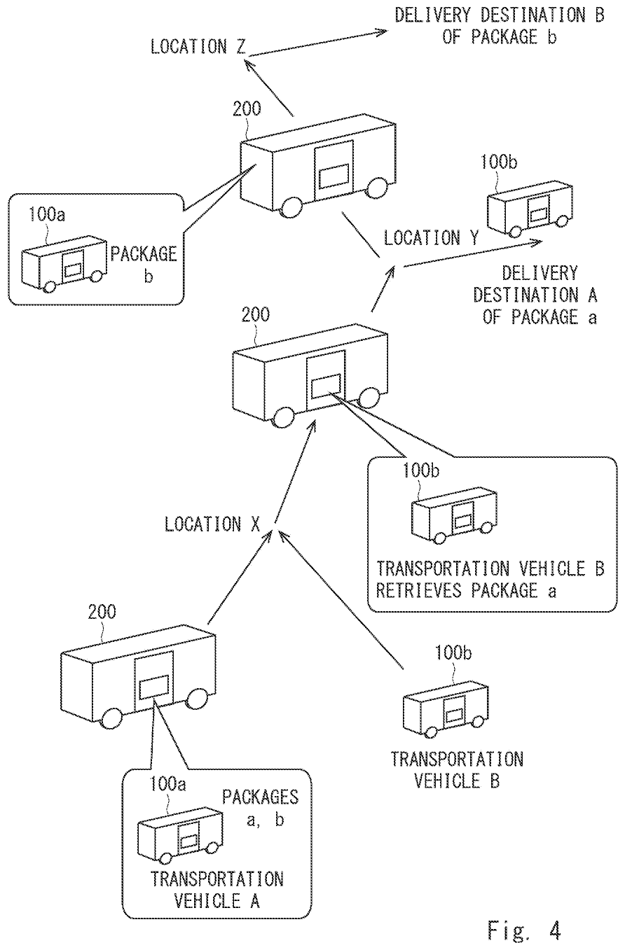

Next, a specific example of the operation plan generated by the server 300 will be described with reference to FIG. 4. FIG. 4 shows an operation plan in which a package a is delivered to a delivery destination A and a package b is delivered to a delivery destination B. The transportation vehicle 100a is at a location close to the delivery origin (e.g. a warehouse or a house) and the transportation vehicle 100b is at a location distant from the delivery origin. The transportation vehicle 100a is also referred to as a transportation vehicle A and the transportation vehicle 100b is also referred to as a transportation vehicle B.

In this case, first, the transportation vehicle 100a receives the packages a and b from the delivery origin and gets into the transportation vehicle 200. The transportation vehicle 100a may place the packages a and b in a collecting spot (e.g. a shelf) inside the transportation vehicle 200 or may hold the packages a and b. Note that the transportation vehicle 100a may place only the package a to be passed at the collecting spot.

Next, the transportation vehicle 200 moves to a location X which is in the vicinity of the transportation vehicle 100b. Then, the transportation vehicle 100b gets into the transportation vehicle 200 at the location X.

Next, the transportation vehicle 100b receives the package a from the transportation vehicle 100a inside the transportation vehicle 200. The transportation vehicle 100b may, for example access the accommodation unit 140 of the transportation vehicle 100a with the drive arm 150 and receive the package a. Further, the transportation vehicle 100b may receive the package a from the package collecting place. Passing of the package a may be performed when the transportation vehicle 200 is stationary or may be performed when the transportation vehicle 200 is traveling.

When passing a package, the transportation vehicle 100a may execute control to release locking of the accommodation unit 140 in response to a request from the transportation vehicle 100b. Further, in the case where locking is provided to the shelf (the collecting spot) inside the transportation vehicle 200, the transportation vehicle 200 may execute control to release locking of the shelf.

In this case, since it is desirable that no unspecified person gets in the transportation vehicle 200, the transportation vehicle 200 may perform control to close the entrance and exit of the transportation vehicle 200. After the transportation vehicle 100b has received the package a, the transportation vehicle 100a may lock the accommodation unit 140. Note that as described above, passing of a package may be performed by a crew member who has confirmed the operation plan.

Next, the transportation vehicle 200 travels to the location Y which is in the area around the delivery destination of the package a. The transportation vehicle 100b gets out of the transportation vehicle 200 at the location Y and delivers the package a to the delivery destination A. After delivering the package a, the transportation vehicle 100b sends a notification to the effect that the delivery of the package a is completed to the server 300. After delivering the package a, the transportation vehicle 100b may move autonomously to a predetermined base or may start a new delivery work in accordance with the new operation plan.

In the case where the transportation vehicle 100a delivers both of the packages a and b, the transportation vehicle 200 needs to standby at the location Y until the transportation vehicle 100a returns. However, according to the transportation management system according to the first embodiment, the transportation vehicle 200 does not need to standby at the location Y and thus it is possible to improve the operation efficiency of operation plan.

Next, the transportation vehicle 200 travels to the point Z which is in the area around the delivery destination B of the package b. The transportation vehicle 100a gets out of the transportation vehicle 200 at the location Z and delivers the package b to the delivery destination B. After delivering the package b, the transportation vehicle 100b may move autonomously to a predetermined base or may start a new delivery work in accordance with the new operation plan.

According to the transportation management system according to the first embodiment, since it is possible to pass a package between the plurality of the first transportation vehicles inside the second transportation vehicle, the package can be delivered efficiently.

Note that in the embodiments described above, while the present disclosure has been described as a hardware configuration, it is not to be limited thereto. It is also possible to implement each processing by causing a CPU to execute a computer program in the present disclosure.

In the aforementioned examples the program includes instructions (or software codes) that, when loaded into a computer, cause the computer to perform one or more of the functions described in the aforementioned embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present disclosure is not limited to the aforementioned embodiments, and can be modified as appropriate without departing from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A transportation management system for managing transportation of a package by a plurality of first transportation vehicles and a second transportation vehicle capable of accommodating the plurality of the first transportation vehicles, the transportation management system comprising
a generation unit configured to generate an operation plan including a transportation route of each of the plurality of the first transportation vehicles and a transportation route of the second transportation vehicle, wherein
the generation unit generates the operation plan for a case where passing of the package between the plurality of the first transportation vehicles inside the second transportation vehicle is permitted.

2. The transportation management system according to claim 1, wherein the second transportation vehicle
has a function of a bus for transporting humans and
performs control to close an entrance and exit of the second transportation vehicle when the package is passed between the plurality of the first transportation vehicles.

3. The transportation management system according to claim 1, further comprising a storage unit configured to store location information of each of the plurality of the first transportation vehicles as management information, wherein
the generation unit generates the operation plan based on the management information.

4. The transportation management system according to claim 3, wherein
the management information further includes at least one of first status information and second status information, the first status information indicating whether or not each of the plurality of the first transportation vehicles is delivering the package and the second status information indicating the availability status of an accommodation unit of each of the plurality of the first transportation vehicles, and
the generation unit generates the operation plan based on at least one of the first status information and the second status information.

5. The transportation management system according to claim 4, wherein
the management information includes both the first status information and the second status information, and
the generation unit generates the operation plan based further on priority levels of the package.

6. A transportation management method of managing transportation of a package by a plurality of first transportation vehicles and a second transportation vehicle capable of accommodating the plurality of the first transportation vehicles, the transportation management method comprising:
a generation step in which a computer generates an operation plan including a transportation route of each of the plurality of the first transportation vehicles and a transportation route of the second transportation vehicle, wherein
in the generation step, the operation plan is generated for a case where passing of the package between the plurality of the first transportation vehicles inside the second transportation vehicle is permitted.

7. A non-transitory computer readable medium storing a program for causing a computer to execute a transportation management method of managing transportation of a package by a plurality of first transportation vehicles and a second transportation vehicle capable of accommodating the plurality of the first transportation vehicles, the transportation management method comprising
a generation step of generating an operation plan including a transportation route of each of the plurality of the first transportation vehicles and a transportation route of the second transportation vehicle, wherein
in the generation step, the operation plan is generated for a case where passing of the package between the plurality of the first transportation vehicles inside the second transportation vehicle is permitted.
